(19) United States
(12) Patent Application Publication
(10) Pub. No.: US 2002/0134543 A1
(43) Pub. Date: Sep. 26, 2002

(54) Connecting device with local heating element and method for using same

(75) Inventors: Kurt A. Estes, Lake Zurich, IL (US); Kevin J. Mc Dunn, Lake In The Hills, IL (US)

Correspondence Address: MOTOROLA, INC., 1303 EAST ALGONQUIN ROAD, IL01/3RD, SCHAUMBURG, IL, 60196

(73) Assignee: MOTOROLA, INC

(21) Appl. No.: 09/812,603

(22) Filed: Mar. 20, 2001

(51) Int. Cl. B32B 7/12; B32B 15/04; C09J 1/00; F28F 27/00

(52) U.S. Cl. 165/277; 428/343; 156/334

(57) ABSTRACT

A connecting device (13), such as for connecting an electronic component (10) to a heat sink (12), or connecting any two objects, includes a thermally activated adhesive (202a) with a local heating element (200) placed in contact therewith. The local heating element (200), such as a wire, may be embedded within the thermally activated adhesive (202a), which may be in sheet form or non-sheet form. When the local heating element (200) is activated, the local heating element cures the adhesive (such as epoxy) within the thermally activated adhesive that is adjacent to the local heating element when, for example, current is passed through the local heating element (200).

### FIELD OF THE INVENTION

The invention relates generally to adhesives for connecting one object to another object, and more particularly to adhesives, such as epoxies, used to attach electronic components to heat sinks.

### BACKGROUND OF THE INVENTION

Adhesives are known that are used to secure electronic components to heat sinks. Such adhesives may be in the form of adhesive sheets that may be, for example, membranes impregnated with thermoplastic compound or thermoset material such as epoxy, or any other suitable adhesive sheets. Adhesive techniques are often used to avoid the use of screws and chips and other mechanical devices to provide an adequate mechanical coupling and thermal conductive path between the electronic component and the heat sink in order to draw heat away from the electronic component. In addition, such adhesives may need to provide electrical conductivity so that the electronic component can be shorted (i.e., grounded) to the heat sink. Alternatively, electrical isolation may be required. In such cases an electrically non-conductive epoxy would be chosen.

Adhesive sheets that are used typically require that the entire heat sink and electronic package be heated to cure the adhesive. Depending upon whether or not the adhesive is of thermoplastic base material or a thermoset material, heat may be re-applied to soften the adhesive. This can require large ovens, and a time consuming curing process. In addition, if an electrically conductive heat adhesive sheet is used, when the electronic components heat up, the components may slide off the heat sink since the adhesive sheet may be, for example, a thermoplastic or a solder paste that may soften when higher temperatures are reached. Moreover, when entire sheets of adhesive such as epoxy-based adhesive sheets, are heated with the entire heat sink and component, additional stress is placed on the electronic components and additional energy resources are consumed when ovens are used for the curing process.

In an unrelated area, such as metal gasket sealing, a metal gasket is known to be made to adhere to two metal flanges using a heating element such as a wire-based heating element that is sandwiched within the metal gasket wherein the wire element serves as the heat “welding” component. Electrical current is passed through the wire to soften the gasket and allow it to adhere to the flanges. When current is later reapplied, the wire is reheated forcing the welding joint to expand and break to effectively unweld the joint. However, as understood, such materials are not suitable for connecting devices for electronic components and do not provide electrical isolation between the welded metal.

According, there exists a need for a connecting device and method that overcomes one or more of the above problems.

### BRIEF DESCRIPTION OF THE DRAWINGS

FIG. 1 is a block diagram depicting a thermally activated adhesive assembly in accordance with one embodiment of the invention, interposed between an electronic component and a heat sink in accordance with one embodiment of the invention;

FIG. 2 is an exploded view illustrating one example of a connecting device having a local heating element and thermally activated adhesive in thermal contact with the heating element in accordance with one embodiment of the invention;

FIG. 3 is a cross-sectional view of an assembled multi-layer assembly that forms a connecting device in accordance with one embodiment of the invention;

FIG. 4 is a cross-sectional view depicting one embodiment of a local heating element within a non-conductive thermally activated adhesive sheet and a pair of thermally conductive sheets that are placed within openings of the thermally activated adhesive sheet, in accordance with one embodiment of the invention.

### DETAILED DESCRIPTION OF THE PREFERRED EMBODIMENT

Briefly, a connecting device, such as for connecting an electronic component to a heat sink, or connecting any two objects, includes a thermally activated adhesive with a local heating element placed in contact therewith. The local heating element, such as a wire, may be embedded within the thermally activated adhesive, which may be in a sheet form or non-sheet form. When the heating element is activated, the heating element cures the adhesive within the thermally activated adhesive that is adjacent to the local heating element when, for example, current is passed through the heating element.

In one embodiment, the connecting device is made of a multi-layer assembly wherein a wire heating element is sandwiched between two layers of high temperature electrically non-conductive epoxy sheets that have openings therein, such as windows, that receive thermally sheets that are suitably sized to fit within the opening. The thermally conductive sheets may be low temperature non-electrically conductive adhesive or electrically conductive solder or conductive adhesive. The wire heating element is serpentined about the windowed thermally activated adhesive sheets and when heated, cures the epoxy adjacent to the heating element without curing the entire sheet, if desired. Since a heating element is local to the adhesive sheet and to the desired electronic component, the entire heat sink need not be heated to cure the epoxy. In addition, in the case where the thermally activated adhesive sheet is a thermoplastic, the heating element can be used to resoften the adhesive for removal of the electronic components from the heat sink.

In one embodiment, a two-piece adhesive sheet is used for mounting electronic components to heat sinks. One piece, an outer adhesive, such as a window frame-type electrically non-conductive (or conductive) sheet, is a high temperature thermoplastic or thermoset sheet. Within the windows is a second piece, such as placed an internal adhesive that is a lower temperature thermoplastic material or low temperature solder (if electrical conductivity is also desired). Embedded in the window-shaped frame adhesive sheet is the heating element. The window framed adhesive sheet provides electrical isolation between the heating element and heat sink/electronic component substrate. This keeps the flow of electricity from short circuiting the heating element through the heat sink or electronic component. The heating element heats up the window-framed thermally activated adhesive sheet. The thermally conductive sheet serving as the internal adhesive may be, for example, an adhesive or low temperature solder, that may be softened by the heat generated by the electronic component during use to provide suitable thermal contact between the heat sink and the electronic component. The window-framed sheet also serves as a type of epoxy frame to prevent the low temperature solder or thermoplastic from leaking out.

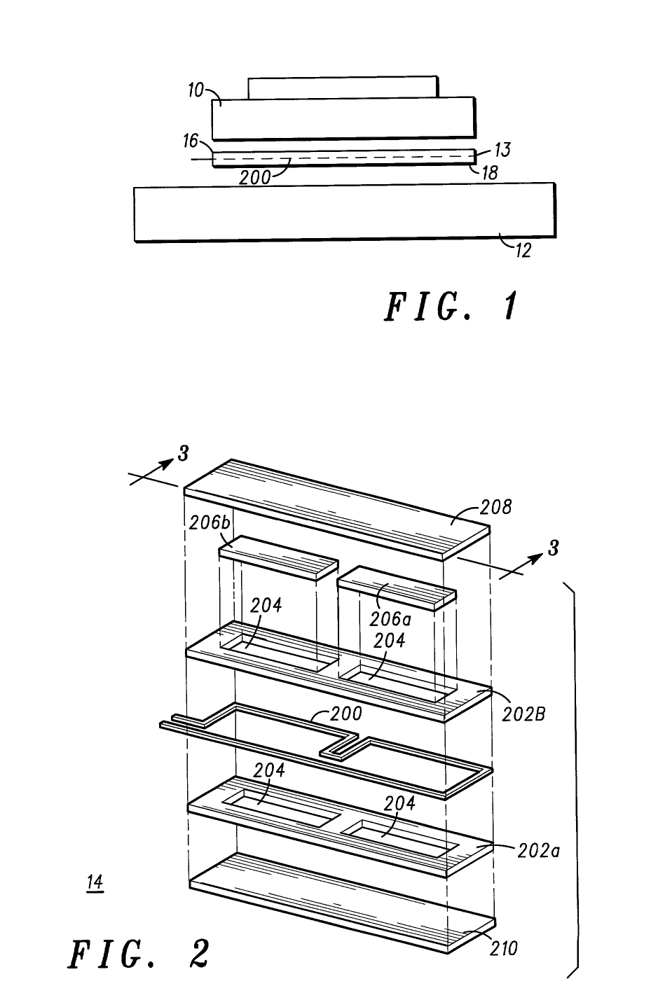

Referring to FIGS. 1-4, an electronic component 10 is connected to a heat sink 12 via a connecting device 13 such as a thermally activated adhesive assembly 14 that contains a local heating element 200 therein. The multi-layer thermally activated adhesive assembly 14 includes a first surface 16 and a second surface 18. The first and second surfaces 16 and 18 may have a layer of low strength adhesive thereon, to allow the electronic component 10 and heat sink 12 to attach with the connecting device 13 prior to activating the local heating element 200 therein.

One example of the connecting device 13 in accordance with one embodiment of the invention will be described with reference to FIGS. 2-4. However, it will be recognized that a non-layered connecting device may also be desirable where, for example, a thermally activated adhesive takes the form of a non-sheet compound and the heating element is embedded therein to allow, for example, a flexible connecting device to connect with objects devices other than electronic components and heat sinks.

The thermally activated adhesive multi-layer assembly 14 includes the local heating element 200, thermally activated adhesive sheet 202a and a second thermally activated adhesive sheet 202b. Each of the thermally activated adhesive sheets 202a and 202b form a thermally activated adhesive that is placed in thermal contact with the heating element 200 when assembled so that the local heating element 200, when a voltage is applied thereto, cures the adhesive that is adjacent to the local heating element 200 when current is passed through the local heating element 200. Accordingly, as shown in FIG. 4, a portion 400 of the thermally activated adhesive that is adjacent to the local heating element 200 is cured by the local heating element 200. It will be recognized that the portion 400 may expand or contract to include differing portions depending upon the amount of heat and the rate at which the local heating element 200 is heated.

The local heating element 200 is preferably a resistive element such as a wire, but may be any suitable heating element. In this embodiment the local heating element 200 is embedded within the combination of the thermally activated adhesive sheets 202a and 202b to prevent contact between the local heating element 200 and the heat sink 12 and/or electronic component 10. The local heating element 200, in a preferred embodiment, is a flat wire having, for example, a rectangular cross section. However, a round wire, square wire, coiled wire or any other suitably shaped local heating element may also be used.

The thermally activated adhesive sheets 202a and 202b each have openings 204 therein to receive one or more thermally conductive sheets 206a and 206b. A cover sheet 208, such as a top cover sheet, and another cover sheet 210, such as a bottom cover sheet, are peeled off from the thermally activated adhesive sheets 202b and 202a respectively leaving a low strength adhesive exposed to contact the base of an electronic component and a top surface of a heat sink, so that the connecting device 13 can be suitably positioned between an electronic component 10 and a heat sink 12 without unnecessary movement during the curing process when using the local heating element 200. The cover sheets 208 and 210 may be, for example, thin paper, a plastic sheet, or any other suitable protective cover layer.

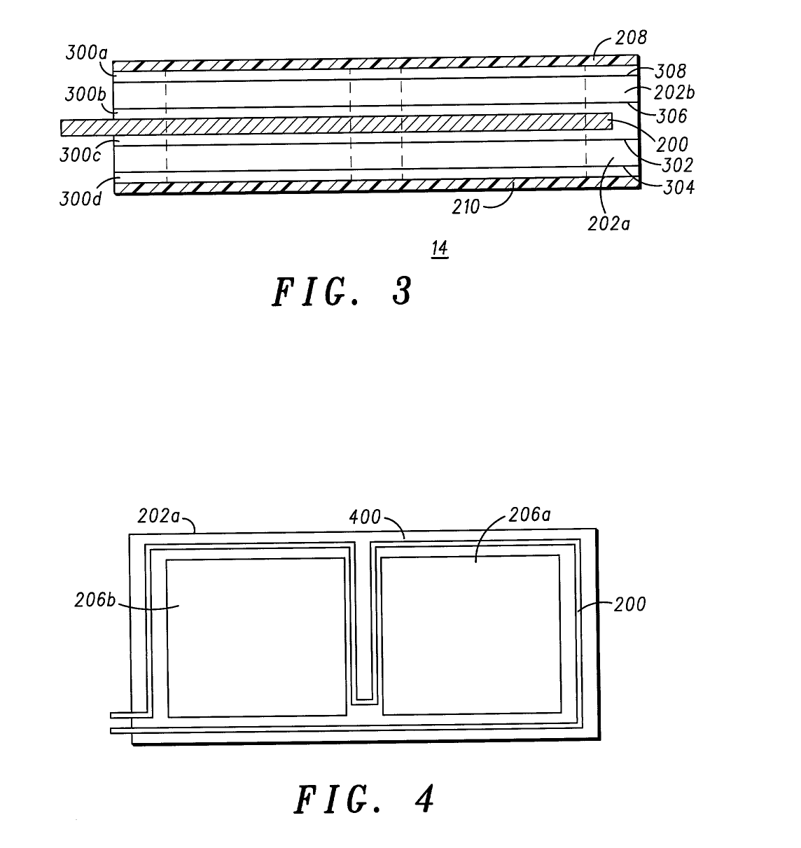

As shown in FIG. 3, the thermally activated adhesive sheets 202a and 202b include a layer of low strength pressure sensitive adhesive layer 300a, 300b, 300c and 300d located on outer surfaces of the thermally activated adhesive sheets 202a and 202b. The low strength adhesive layers may be a continuous thin layer or discontinuous adhesive portions that allow for coupling of the thermally activated adhesive sheets 202a and 202b to one another and for placement on the heat sink 12 and electronic component 10 after the cover sheets 208 and 210 are removed. Preferably, the thermally activated adhesive sheets 202a and 202b are made from a high temperature, non-conductive epoxy sheet cut in a window frame pattern wherein the openings 204 form the windows and an outer portion forms a frame. It will be recognized that any suitable member, shape and sized openings (i.e., windows) may be used depending on the application. One type of suitable high temperature non-conductive epoxy sheet (or electrically non-conductive) may be, for example, MP5401 type high temperature electrically non-conductive epoxy sheet available from Adhesive Systems Technology in Minneapolis, Minn. This type of thermally activated adhesive sheet contains a thermoset material meaning that they are cured using high temperatures. If desired, a thermoplastic sheet may also be used such that the reheating of the thermoplastic causes the thermally activated adhesive sheets 202a and 202b to soften to allow the connecting device to be removed to disconnect the electronic component 10 from the heat sink 12 upon the reapplication of heat through the local heating element 200.

The thermally conductive sheets 206a and 206b, although shown to be in rectangular shape, may be any suitable shape and size to, for example, as desired to provide a suitable conductive surface for the electronic component to pass heat from the electronic component through to the heat sink. One suitable type of material for the thermally conductive sheets 206a and 2206b is a low temperature thermally conductive epoxy sheet by the name of Omegatherm 200 from Omega Engineering, Inc. in Stamford, Conn. In this embodiment, the thermally conductive sheet 206a and the other thermally conductive sheet 206b are also electrically non-conductive to electrically isolate the electronic component 10 from the heat sink 12. However, in other applications it may be desirable to ground the electronic component 10 to the heat sink 12, for example. As such, a suitable thermally conductive sheet material may be, for example, a low temperature thermally conductive and electrically conductive adhesive (or epoxy) sheet. Also, it may be desirable to use a low temperature electrically conductive solder which may come in the form of an impregnated membrane to form a sheet, or may be in the form of a paste. If a low temperature solder is used, the epoxy frame formed by a cured thermally activated adhesive sheet 202a and 202b form a frame from which a molten solder cannot readily escape.

The thermally activated adhesive sheet 202a has a first outer surface 302 having thereon a medium strength adhesive 300c and a second outer surface 304 having the low strength adhesive 300d. Similarly, the thermally activated adhesive sheet 202b has an outer surface 306 having thereon a medium strength adhesive 300b and an outer surface 308 having the low strength adhesive 300a thereon. A medium strength adhesive is used as adhesive 300b and 300c so that a slightly stronger band is used to connect the heating element in proximity to the thermally activated adhesive sheets 202a and 202b. Other variations will be recognized by those of ordinary skill in the art.

The local heating element 200 may be embedded in one of the thermally activated adhesive sheets 202a and 202b, or as shown, may be sandwiched between the plurality of thermally activated adhesive sheets 202a and 202b. When the heating element 200 is embedded in one of the thermally activated adhesive sheets 202a or 202b, it is in operative contact, with the other thermally activated adhesive sheet to provide localized heat to only portions of the thermally active adhesive sheets that are adjacent to the heating element. Accordingly, the heating element 200 can provide enough heat when embedded within one of the thermally activated adhesive sheets, to also suitably cure epoxy in the other thermally activated adhesive sheet. This may be accomplished, for example, by having a suitably sized heating element and applying a suitable amount of current through the heating element to provide the requisite amount of heat to cure desired portions of the other thermally activated adhesive sheet.

Although not shown, the multi-layer assembly 14 that forms the connecting device 13 may include locating notches or apertures to suitably locate the connecting device 13 to align with a suitable portion of the electronic component and heat sink.

The local heating element 200 may be serpentined in a manner to traverse the thickness of the thermally activated adhesive sheet. As shown, for example, in FIG. 4, the local heating element 200 is local to the epoxy and is also local to a different thermally conductive material such as the thermally conductive sheet 206a and/or 206b. The local heating element 200 is used to heat up the epoxy (i.e., adhesive) in the window framed thermally activated adhesive sheets 202a and 202b. Depending upon the type of material used, this will either cure a thermoset or soften a thermoplastic in the sheet. Since the local heating element 200 is located within or adjacent to the adhesive in the sheet, the entire heat sink need not be heated to cure the epoxy. In the case of thermoplastic being used, the local heating element 200 may be used to soften the frame for removal of the electronics. Also if desired, the local heating element 200 may be serpentined and can also heat the thermally conductive sheets 206a and 206b. This may be done, for example, when an electronic device is shorted to a heat sink.

A method for attaching an electronic component 10 to a heat sink 12 can be carried out as follows. The localized heating element 200 in combination with the thermally activated adhesive assembly (e.g., 202a, 200 and 202b) is placed between the electronic component and the heat sink. This may be done, for example, by a suitable machine or a manual process, if desired. Once the connecting device is interposed between electronic component and the heat sink, the method includes controlling the heat emitted from the localized heating element 200 to control curing of the adhesive within the thermally activated adhesive sheets to mechanically connect the electronic component to the heat sink. Controlling heat emitted from the localized heating element may include controlling current through the heating element using a variable voltage source, current source or any suitable control device. This may be done via computer control, or any other suitable mechanism. If desired, a quick connector may be placed on the terminal ends of the heating element to quickly disconnect therefrom when curing is complete. The thermally activated adhesive assembly, which contains, for example, at least one of the thermally activated adhesive sheets 202a and 202b, includes curable adhesive in sheet form. The localized heating element may be a flat wire positioned on or in the adhesive that is in sheet form. When the heat is controlled to cure the epoxy within the thermally activated adhesive sheet, a first surface, such as an outer surface of the assembly, is adhered to the electronic component and another outer surface, such as a bottom surface of the assembly, is adhered to the assembly of the heat sink. Alternatively, the localized heating element and thermally activated adhesive assembly may be a structure other than a multi-layered structure and may simply be a wire passed through a liquid epoxy that may be, for example, in non-sheet form.

After the electronic component has been attached to heat sink or other surface, the electronic device may be suitably removed by reapplying heat using the localized heating element where, for example, the thermally activated adhesive assembly includes a thermoset-based compound which softens upon exposure to heat. Accordingly, the electronic component may be removed from the heat sink.

As described herein, in one embodiment, a multi-layer assembly combines a plurality of different kinds of adhesive sheets, such as a high temperature thermally activated adhesive sheet that provides structure for a low temperature thermally conductive sheet (lower temper activation with respect to the high temperature sheet) that provides thermal conductivity that is placed, for example, within an opening in the high temperature thermally activated sheet. A local heating element is then used to cure or soften the high temperature thermally activated adhesive sheet.

It will be recognized, that when curing a thermoset based thermally activated sheet, and when using a low temperature solder paste as the thermally conductive sheet, to, for example, ground the electronic component to the heat sink, preferably the wire heating element is positioned so that the amount of heat generated therefrom cures epoxy near the wire but not enough heat is used to cause the low temperature solder to reflow until the epoxy sets to form a suitable epoxy frame for the low temperature solder paste.

When placing a connecting device that is made, for example, from the afore-described multi-layer assembly, the cover sheets are peeled off to expose the low strength adhesive so that the low strength adhesive can be used to adhere to one surface, such as a top surface of the assembly to an electronic component, and a bottom surface to the heat sink.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A method for attaching an electronic component to a heat sink comprising:
placing a localized heating element and thermally activated adhesive assembly between the electronic component and the heat sink; and
controlling heat emitted from the localized heating element to control curing of the adhesive to mechanically connect the electronic component to the heat sink.

2. The method of claim 1 wherein the step of controlling heat emitted from the localized heating element includes at least one of: controlling current through and controlling voltage across the heating element.

3. The method of claim 1 wherein the thermally activated adhesive assembly includes curable adhesive in sheet form and wherein the localized heating element is a flat wire positioned on the adhesive in sheet form.

4. The method of claim 1 wherein the step of placing the localized heating element and thermally activated adhesive assembly between the electronic component and the heat sink includes adhering a first surface of the assembly to the electronic component, and adhering a second surface of the assembly to the heat sink.

5. The method of claim 1 including after controlling the heat emitted from the localized heating element to mechanically connect the electronic component, subsequently controlling heat emitted from the localized heating element to soften the adhesive to remove the electronic component.

6. A connecting device comprising:
a local heating element; and
thermally activated adhesive in thermal contact with the heating element such that the heating element cures the adhesive adjacent the local heating element when current passes therethrough.

7. The device of claim 6 wherein the heating element includes a wire.

8. The device of claim 7 wherein the wire is a flat wire.

9. The device of claim 7 including a multi-layer assembly including:
a first cover sheet;
a second cover sheet; and
interposed between the first and second cover sheets,
a first thermally activated adhesive sheet containing at least a portion of the thermally activated adhesive, having an opening therein to receive at least one thermally conductive sheet;
the local heating element in operative contact with the first thermally activated adhesive sheet; and
a second thermally activated adhesive sheet containing at least a portion of the thermally activated adhesive, also having an opening therein to receive the at least one thermally conductive sheet.

10. The device of claim 9 wherein the at least one thermally conductive sheet is from the group of: a low temperature electrically conductive adhesive, a low temperature electrically conductive solder, and a low temperature non-electrically conductive adhesive.

11. The device of claim 9 wherein the first and second thermally activated adhesive sheets are made from at least a high temperature non-conductive epoxy sheet.

12. The device of claim 11 wherein the first and second thermally activated adhesive sheets are made from the group of: thermosets and thermoplastics.

13. The device of claim 9 wherein the first and second thermally activated adhesive sheets each include an adhesive on an outer surface thereof.

14. A connecting device comprising:
a multi-layer assembly that includes:
a first cover sheet;
a second cover sheet; and interposed between the first and second cover sheets,
a first thermally activated adhesive sheet containing at least a portion of thermally activated adhesive, having an opening therein to receive at least one thermally conductive sheet;
a local wire heating element in operative contact with the first thermally activated adhesive sheet; and
a second thermally activated adhesive sheet containing at least a portion of more thermally activated adhesive, also having an opening therein to receive the at least one thermally conductive sheet
wherein the thermally activated adhesive is in thermal contact with the local heating element such that the local heating element cures adhesive adjacent the local heating element when current passes therethrough.

15. The device of claim 14 wherein the at least one thermally conductive sheet is from the group of: a low temperature electrically conductive adhesive, a low temperature electrically conductive solder, and a low temperature non-electrically conductive adhesive.

16. The device of claim 14 wherein the first and second thermally activated adhesive sheets are made from at least a high temperature non-conductive epoxy sheet.

17. The device of claim 16 wherein the first and second thermally activated adhesive sheets are made from the group of: thermosets and thermoplastics.

18. The device of claim 14 wherein the first and second thermally activated adhesive sheets each include an adhesive on a surface thereof.

19. The device of claim 14 wherein the local heating element is embedded in the first thermally activated adhesive sheet and in operative contact with the second thermally activated adhesive sheets to provide localized heat to only portions of the thermally activated adhesive sheets.
